(19) United States
(12) Patent Application Publication
(10) Pub. No.: US 2012/0191463 A1
(43) Pub. Date: Jul. 26, 2012

(54) ONE CLICK LEAD REJECTION

(76) Inventor: Steve Crim, Fairhope, AL (US)

(21) Appl. No.: 13/012,080

(22) Filed: Jan. 24, 2011

(51) Int. Cl. G06Q 99/00; G06F 17/00; G06F 15/16

(52) U.S. Cl. 705/1.1; 709/217; 715/205

(57) ABSTRACT

A method, apparatus, and computer readable storage to implement a lead rejection system. Sales leads are presented to recipients with a link embedded inside the lead which when clicked, serves to immediately generate a brand new lead for the recipient. Thus, when the recipient considers a lead to be a defective one, the recipient can easily click the link to remedy the situation.

### BACKGROUND OF THE INVENTION

1. Field of the Invention

The present general inventive concept is directed to a method, apparatus, and computer readable storage medium directed to a contact management system with a streamlined lead rejection/replacement system.

2. Description of the Related Art

Contact management systems allow salesman to purchase leads. A lead can be identifying information (name, telephone number, address, e-mail address, etc.) of a potential customer interested in a particular product. For example, when a person visits a web site involving cars the web site may ask the visitor for his or her contact information and interests so that the contact information can be passed on to a salesman that can contact the visitor to attempt to sell the visitor a product related to what they are interested in. This benefits both the visitor (because they are contacted by someone who can help them with their needs) and the salesman (who benefits from contacting leads in order to make sales).

Sometimes leads that are purchased by the salesman can be bad. What is needed is an easy for a purchaser of a bad lead to easily replace the bad lead with a fresh lead.

### SUMMARY OF THE INVENTION

It is an aspect of the present invention to provide an improved way to replace sales leads.

The above aspects can be obtained by (a) retrieving a lead; (b) generating a lead communication which comprises the lead with an embedded rejection link; and (c) transmitting the lead communication to a recipient, (d) wherein the embedded rejection link when clicked performs retrieving a new lead, generating a new lead communication, and transmitting the new lead communication to the recipient.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating an exemplary method of distributing leads with an embedded reject operation, according to an embodiment;

FIG. 2 is a drawing of a screen illustrating a lead with an embedded reject operation, according to an embodiment;

FIG. 3 is a block diagram illustrating a network of participants implementing methods described herein, according to an embodiment;

FIG. 4A is a flowchart illustrating a method used to transmit a replacement lead, according to an embodiment;

FIG. 4B is a drawing of a screen illustrating a prompt window receiving an explanation for a bad lead, according to an embodiment;

FIG. 5 is a block diagram of hardware that can be used to implement any of the digital computers/servers described herein, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method, apparatus, and computer readable storage medium to implement a method for lead generation which allows a recipient of a lead to immediately reject a bad lead simply by clicking a link (or button) on the lead itself. A bad lead is a lead that has a bad phone number, bad email address, bad physical address, or some other reason why the lead is worthless to the recipient.

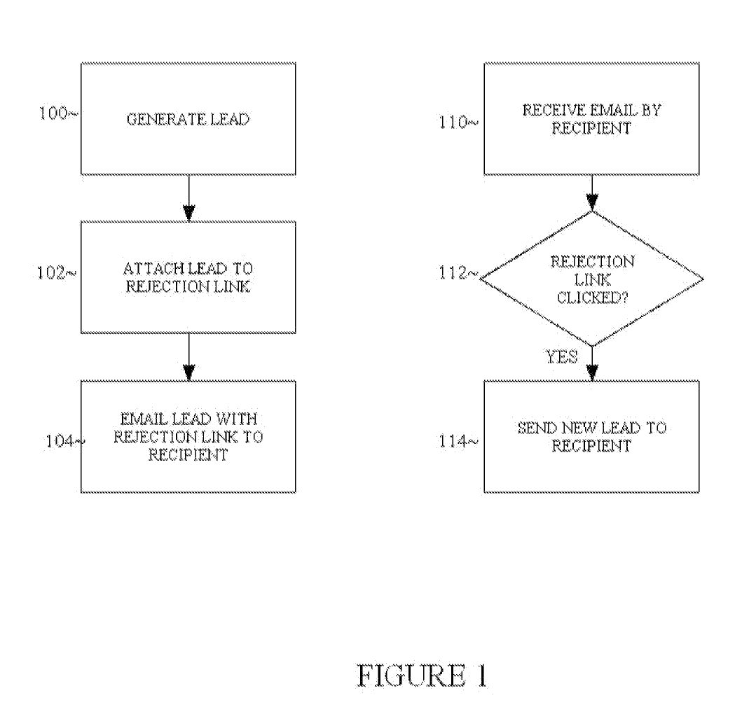

FIG. 1 is a flowchart illustrating an exemplary method of distributing leads with an embedded reject operation, according to an embodiment;

The method can begin with operation 100, which generates a lead. This can be done as known in the art. For example, a web site can have a contact page which receives contact information from a visitor where the visitor can also indicate his or her preferences (e.g., type of product they are looking for). This lead can then be stored in a database. The leads in the database can then be queued in order to remove them one at a time when leads are generated.

From operation 100, the method proceeds to operation 102, which takes a generated lead, generates an email (or other transmission) containing the lead and attaches a lead rejection link (or button) to the email. The link links to a page which has functionality which will automatically generate a new lead to a recipient of the lead.

From operation 102, the method proceeds to operation 104, which emails the lead with the rejection link to the recipient.

In operation 110, the email transmitted in operation 104 is received by the recipient.

From operation 110, the method proceeds to operation 112, which determines if the rejection link in the email was clicked.

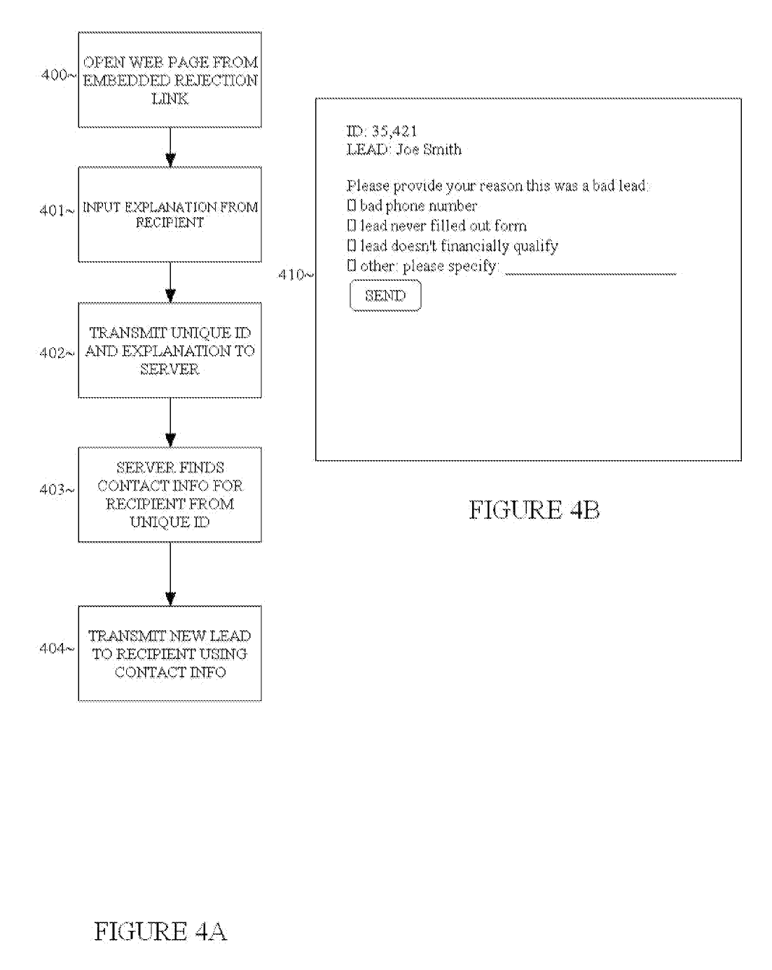

If the rejection link was clicked, then the method proceeds to operation 114, which sends out a new lead to the same recipient by replace the rejected lead. See FIGS. 4A and 4B for a detailed explanation of how this is done.

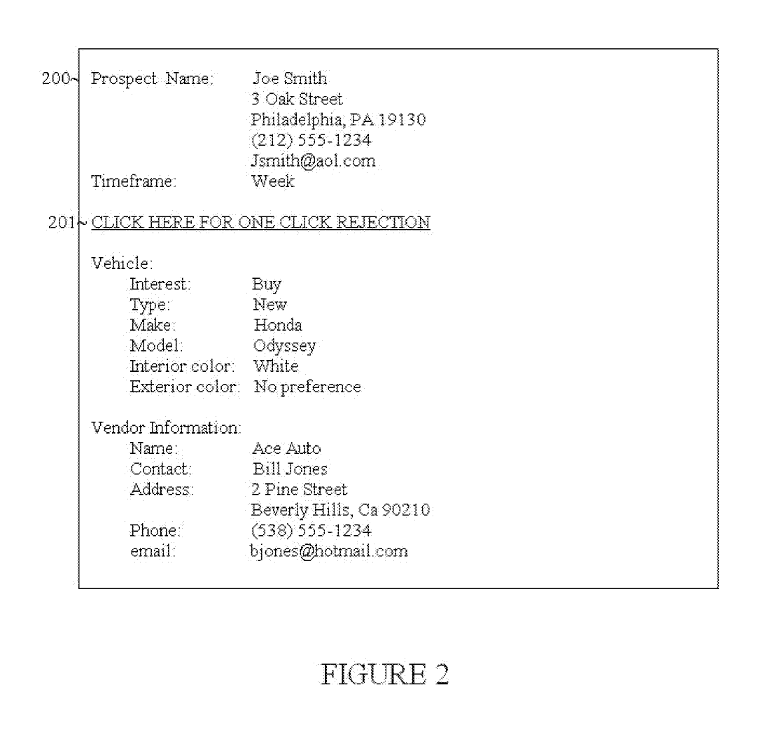

FIG. 2 is a drawing of a screen illustrating a lead with an embedded reject operation, according to an embodiment.

A lead window 200 shows a lead which is communicated to a recipient (via email, database, etc.) The lead window shows the name of a lead (“Joe Smith”) that visited a web site with information about automobiles. The lead voluntarily entered his contact information into a contact information window on the web site so that he could be contacted by an appropriate vendor with further information about the product he is interested in (in this example, cars). Since Joe Smith indicated that he is interested in a HONDA ODYSSEY, the lead can be routed (by the lead management server) to a vendor (recipient) that carries this product so that the vendor can provide information about this product to the lead and hopefully make a sale to the lead.

A one click rejection link 201 is embedded directly inside the lead window 200. The one click rejection link 201 has functionality such that when clicked, the current lead in the lead window 200 is retracted and the recipient is presented with a brand new lead.

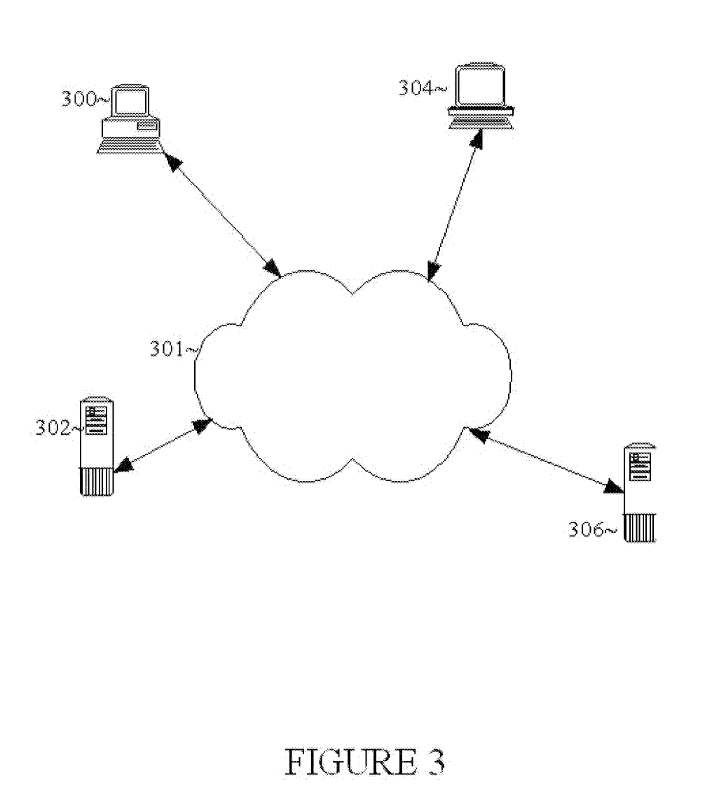

FIG. 3 is a block diagram illustrating a network of participants implementing methods described herein, according to an embodiment.

A potential buyer (e.g., “Joe Smith” from FIG. 2) uses his or her home computer 300 to browse a computer communication network 301 such as the Internet. The buyer can visit a web site hosted by a server 302, the web site being maintained by a company that manufactures products. The buyer can browse the web site and visit a contact page on the web site wherein the buyer can enter his or her own contact information into the contact page so that the buyer can receive a call back (or email, etc.) from a salesman who sells the product the buyer is interested in.

The server 302 can then transmit the buyer's information generated from the contact page (the buyer's name, address, telephone number, email, etc.) to a lead database 306. The lead database 306 stores leads received from the server 302 (and other servers not pictured). The database 306 generates an email (or other communication) containing the buyer's information and transmits this information (a lead such as illustrated in FIG. 2) to a recipient 304 (e.g., “Bill Jones” from FIG. 2). The recipient is a vendor that sells the product that the buyer is potentially interested in.

If the recipient 304 determines that the lead is defective, then the recipient can click a rejection link embedded inside the transmitted lead, and the rejection link automatically communicates with the database 306 to instruct it to send a brand new lead to the recipient 304. The brand new lead will also have an embedded rejection link which can also be clicked if the recipient find the brand new lead is also defective, which would have the same functionality (that is, instruct the database 306 to send a brand new lead to the recipient 304).

FIG. 4A is a flowchart illustrating a method used to transmit a replacement lead, according to an embodiment.

In operation 400, a web page is opened (on the recipients computer after the recipient clicked the link in operation 112) that is associated with a URL embedded in the rejection link. A web page pre-exists on that URL for the purpose of providing a new lead for the recipient. The web page is opened as known in the art, by using a web browser that downloads the HTML code associated with the URL (and runs associated applications/script contained therein). The web page associated with the URL also contained information about the recipient, such as the recipient's contact info (e.g., name, e-mail address, ftp address, etc.)

An applet/script is contained on web page which operates to bring up a window 410 which prompts the recipient to provide the explanation for the rejection (See FIG. 4B) and performs the other functionality described herein.

From operation 400, the method proceeds to operation 401, which receives the explanation from the recipient (see window 410 in FIG. 4B). The recipient can enter his or her explanation and press the ‘send’ button.

From operation 401, the method proceeds to operation 402, which transmits the explanation to the server along with the unique ID so that the server can identify who the recipient is.

From operation 402, the method proceeds to operation 403, which is performed at the server level. The server receives the transmission from the recipients computer from operation 402, and looks up the actual contact info of the recipient associated with the unique ID (identifier) in a database associated with the server. This is how the systems knows who the recipient actually is so that the recipient can be sent a new lead.

From operation 403, the method proceeds to operation 404, which transmits a new lead to the recipient. This can be done by returning to operation 100 for the recipient.

FIG. 4B is a drawing of a screen illustrating a prompt window receiving an explanation for a bad lead, according to an embodiment.

When a rejection link is clicked by the recipient, a web page window 410 is displayed to allow the recipient to enter an explanation why the lead associated with the rejection link that was clicked was bad. The recipient will designate his or her answer (by clicking a box or writing in the explanation) and click (using a mouse, etc.) send, which initiates operation 402.

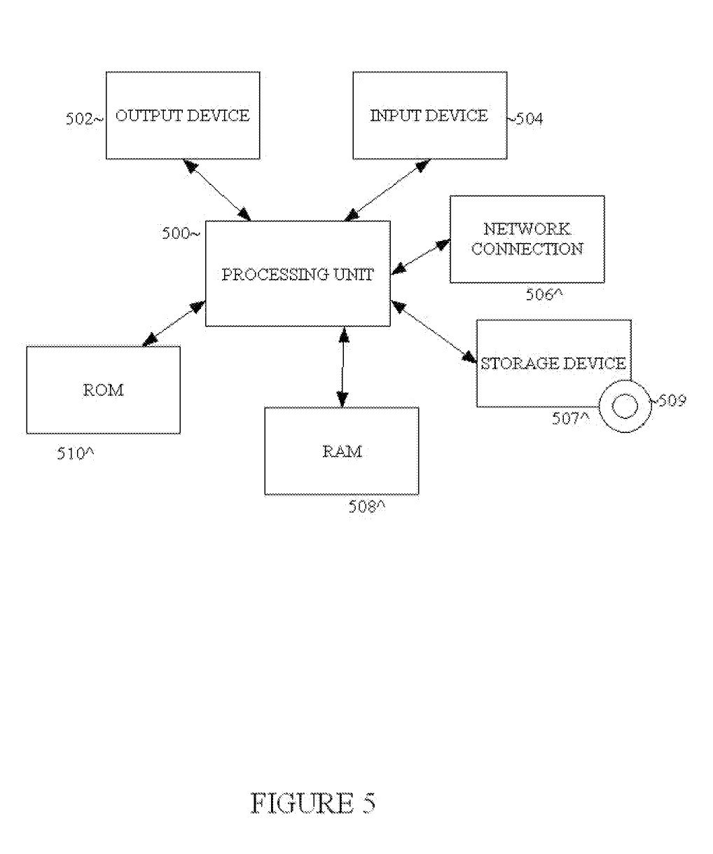

FIG. 5 is a block diagram of hardware that can be used to implement any of the digital computers/servers described herein, according to an embodiment.

A processing unit 500 (such as a microprocessor and associated apparatus such as bus, cache, etc.) can be connected to an output device 502 (such as an LCD screen, touch-screen, speaker, etc.) and an input device 504 (such as a touch-screen, keyboard, mouse, buttons, etc.) The processing unit 500 can also be connected to a network connection 506 (such as an LAN, WAN, wifi, Internet, etc.) The processing unit 500 can also be connected to a RAM 508 and a ROM 510. The processing unit 500 can also be connected to a storage device 507 (e.g., hard disk, CD-ROM, DVD-drive, BLU-RAY, EPROM, etc.) which can read an appropriate computer readable storage medium 509 (such as a CD-ROM, etc.) that stores a program that controls the processing unit 500 to implement any of the methods described herein.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method to distribute leads from a lead provider to a recipient, comprising:
retrieving a lead from a lead source;
generating a lead communication which comprises the lead with an embedded rejection link; and
transmitting the lead communication to a recipient,
wherein the embedded rejection link when clicked performs automatically requesting a new lead from the lead source and receiving the new lead from the lead source.

2. The method as recited in claim 1, wherein when the embedded rejection link is clicked the lead source automatically generates the new lead and transmits the new lead to the recipient.

3. The method as recited in claim 1, further comprising, when the rejection link is clicked then notifying the lead source that the lead was rejected.

4. The method as recited in claim 1, wherein when the rejection link is clicked then forward the lead back to the lead source.

5. The method as recited in claim 1, wherein the new lead is transmitted manually to the recipient.

6. The method as recited in claim 1, wherein the new lead is transmitted automatically to the recipient.

7. The method as recited in claim 1, wherein the recipient is not charged for the new lead communication.

8. The method as recited in claim 7, wherein the recipient pays a fixed cost for a predetermined number of leads, wherein leads that have their rejection link clicked are not counted as part of the predetermined number of leads.

9. The method as recited in claim 7, wherein the recipient is permitted by the lead source to reject the lead communication and receive the new lead for any reason.

10. The method as recited in claim 7, wherein the recipient is permitted by the lead source to reject the lead communication and receive the new lead only for the lead communication being of poor quality.

11. The method as recited in claim 1, wherein the recipient is charged for the new lead communication.

12. A method to distribute leads from a lead provider to a recipient, comprising:
retrieving a lead;
generating a lead communication which comprises the lead with an embedded rejection link; and
transmitting the lead communication to a recipient,
wherein the embedded rejection link when clicked performs granting a credit for the lead to the recipient.

13. The method as recited in claim 12, wherein the credit is financial.

14. The method as recited in claim 12, further comprising, when the rejection link is clicked then notifying the lead source that the lead was rejected.

15. The method as recited in claim 12, wherein when the rejection link is clicked then forward the lead back to the lead source.

16. The method as recited in claim 12, wherein the new lead is transmitted manually to the recipient.

17. The method as recited in claim 12, wherein the new lead is transmitted automatically to the recipient.
